(19) United States
(12) Patent Application Publication
(10) Pub. No.: US 2025/0116584 A1
(43) Pub. Date: Apr. 10, 2025

(54) AUTOMATED DEVICE FOR DETECTING A PRESENCE OF A PATHOGEN IN A FLUID SAMPLE

(71) Applicant: Ecoli Sense Limited o/a Kraken Sense, Oakville (CA)

(72) Inventors: Jamal Zeinalov, Oakville (CA); Winston Lord, Oakville (CA); Yin Chung Leung, Oakville (CA); Mohd Afiq Bin Mohd Asri, Oakville (CA); Adam Carnaffan, Oakville (CA); Yagya Paudel, Oakville (CA)

(21) Appl. No.: 18/906,865

(22) Filed: Oct. 4, 2024

Related U.S. Application Data
(60) Provisional application No. 63/542,659, filed on Oct. 5, 2023.

(51) Int. Cl. G01N 1/40; G01N 35/00; G01N 35/10

(52) U.S. Cl. CPC G01N 1/4077; G01N 35/10; G01N 2001/4083; G01N 2035/00495

(57) ABSTRACT

An automated device and method for detecting a presence of a pathogen or a chemical in a fluid sample are disclosed. The device has an on-board holding tank configured to store the fluid sample; an on-board fully automated centrifuge for sample concentration; a first on-board peristaltic pump configured to pump the fluid sample into the centrifuge; an automated fluidics sensor management system; a rapid qPCR heating system; a fluidics sensor rotation and articulation system; an electrical signal detection system; a lid heating assembly system; and an automated sample to fluidics sensor deposition system. An automated fluidics sensor management system and an automated qPCR instrument for use with the device are also disclosed.

### CROSS-REFERENCE

The present application claims the benefit of U.S. Provisional Patent Application No. 63/542,659 entitled “AN AUTOMATED DEVICE FOR DETECTING A PRESENCE OF A PATHOGEN OR A CHEMICAL IN A FLUID SAMPLE”, filed on Oct. 5, 2024, the entire contents of which are hereby incorporated by reference in their entirety.

### FIELD

Various embodiments are described herein that generally relate to an automated device for detecting a presence of a pathogen or a chemical in a fluid sample, as well as the related systems and methods.

### BACKGROUND

The following paragraphs are provided by way of background to the present disclosure. They are not, however, an admission that anything discussed therein is prior art or part of the knowledge of persons skilled in the art.

Pathogen detection in fluid samples using molecular techniques requires a sample treatment process which yields a suspension of target nucleic acids which is sufficiently free of PCR inhibitors, interferents, and non-target nucleic acids. The sample treatment process is closely tied to the amplification and detection techniques utilized and as such are vital to sensitive and specific detection of target microbes.

Existing methods of performing sample preparation on fluid samples typically consist of the following steps: (a) the fluid sample is subjected to some means of lysing, either selectively or non-selectively with respect to the target microbes; (b) removal or inactivation of inhibitors and interferents to PCR and detection; and (c) removal of non-target nucleic acid or enhanced amplification and detection strategies for increasing specificity with respect to target microbes and live versus dead microbes.

These steps are typically performed either separately or in combination and with varying levels of efficacy in accordance with the tolerance characteristics of downstream processes. Most existing pathogen detection platforms rely on extraction and purification of the target nucleic acids prior to amplification and detection using PCR or RT-PCR, and are poorly suited for automation in applications involving low pathogen concentrations.

There is a need for a device and method that addresses the challenges and/or shortcomings described above.

### SUMMARY OF VARIOUS EMBODIMENTS

Various embodiments of a device and method for detecting a presence and quantity of a pathogen or chemical in a fluid sample, and computer products for use therewith, are provided according to the teachings herein.

According to one aspect of the invention, there is disclosed an automated device for detecting a presence of one or more of a pathogen and one or more strains of a pathogen or a chemical in a fluid sample, the device comprising: an on-board holding tank configured to store the fluid sample; an on-board fully automated centrifuge for sample concentration of the fluid sample, the centrifuge being in fluid communication with the holding tank; a first on-board peristaltic pump configured to pump the fluid sample from the holding tank into the centrifuge; an automated fluidics sensor management system operable to transport one or more fluidics sensors to the centrifuge or a qPCR instrument; a rapid qPCR heating system operable to heat the qPCR instrument; a fluidics sensor rotation and articulation system configured to receive the one or more fluidics sensors; an electrical signal detection system operable to detect motion of the centrifuge; a lid heating assembly system operable to heat the one or more fluidics sensors; and an automated sample to fluidics sensor deposition system configured to receive the one or more fluidics sensors by the centrifuge after use.

According to another aspect of the invention, there is disclosed an automated fluidics sensor management system for use with a device for detecting a presence of one or more of a pathogen and one or more strains of a pathogen or a chemical in a fluid sample, the system comprising: a holding container; one or more fluidics sensors disposed within the holding container that are configured to interface with an automated sample deposition and extraction mechanism of the device; a holding tray movable along a surface of the system from a first position to a second position and from the second position to a third position; a mechanism configured to deposit each of the one or more fluidics sensors onto the holding tray, one at a time; an automated qPCR instrument configured to interface with the one or more fluidics sensors; and a disposal drum for storing the one or more fluidics sensors.

According to another aspect of the invention, there is disclosed an automated qPCR instrument for use with a device for detecting a presence of one or more of a pathogen and one or more strains of a pathogen or a chemical in a fluid sample, the automated qPCR instrument comprising: a hollow cylindrical body configured to receive a fluidics sensor; two or more temperature-regulated blocks arranged along an inner circumference of the hollow cylindrical body; a first motor assembly for rotating the fluidics sensor; a second motor assembly for spinning the fluidics sensor; and a lid heating temperature block located on a top side of the fluidics sensor.

According to another aspect of the invention, there is disclosed a method of centrifugation of a fluid sample, the method comprising: depositing the fluid sample into an on-board holding tank; pumping the fluid sample into one or more flasks of an on-board fully automated centrifuge by a first on-board peristaltic pump, the centrifuge comprising a central spinning column and a centrifuge shroud; spinning the one or more flasks around the central spinning column of the centrifuge by a high-speed motor, thereby causing centrifugation of the fluid sample to produce a concentrate and a supernatant; controlling a position of the central spinning column by a retractable armature; placing the retractable armature in an engaged position to make a wheel come into contact with the centrifuge shroud; rotating the wheel to cause the centrifuge shroud to rotate; deploying an automated sample deposition and extraction mechanism into at least one of the one or more flasks after the at least one of the one or more flasks has been positioned by the retractable armature; and extracting the concentrate and the supernatant from the one or more flasks.

According to another aspect of the invention, there is disclosed a method of detecting a presence of one or more of a pathogen and one or more strains of a pathogen or a chemical in a fluid sample, the method comprising: depositing each of the one or more fluidics sensors, one at a time, onto a holding tray in a first position; moving the one or more fluidics sensors to a second position; interfacing the one or more fluidics sensors with an automated qPCR instrument; moving the one or more fluidics sensors to a third position adjacent to a disposal drum; lifting the one or more fluidics sensors by a linear actuator activated platform into the disposal drum from an original position to a stored position; and lowering the platform to the original position while the one or more fluidics sensors remain in the disposal drum.

According to another aspect of the invention, there is disclosed a method of detecting a presence of at least one of a pathogen and at least one strain of a pathogen or a chemical in a fluid sample using an automated qPCR instrument, the method comprising: placing a fluidics sensor adjacent to two or more temperature-regulated blocks arranged along an inner circumference of a hollow cylindrical body; setting each of the two or more temperature-regulated blocks to corresponding temperatures according to a protocol for the fluidics sensor for qPCR analysis; rotating the fluidics sensor via a first motor assembly located adjacent to the two or more temperature-regulated blocks; and spinning the fluidics sensor via a second motor assembly located adjacent to the fluidics sensor.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 shows a perspective view of an example embodiment of a device for detecting a presence of a pathogen and strains of a pathogen or a chemical in a fluid sample.

FIG. 2 shows a perspective view of an example of the interior of the device of FIG. 1.

FIG. 3 shows a plan view of an example of the location of a centrifuge in the device of FIG. 1.

FIG. 4 shows a second perspective view of an example of the interior of the device of FIG. 1.

FIG. 5 shows an isolated view of an example of a qPCR heating system for use with the device of FIG. 1.

FIG. 6 shows a perspective view of an example of an optical signal detection system for use with the device of FIG. 1.

FIG. 7 shows a second plan view of an example of the location of the centrifuge in the device of FIG. 1.

FIG. 8 shows a perspective view of an example of the centrifuge for use with the device of FIG. 1.

FIG. 9A shows a cross-sectional view of an example of the centrifuge of FIG. 8.

FIG. 9B shows a disengaged position of an example of the contact arm shown in FIG. 9A.

FIG. 10A shows a cross-sectional view of an example of the centrifuge of FIG. 8 in an engaged position.

FIG. 10B shows an engaged position of an example of the contact arm shown in FIG. 10A.

FIG. 11 shows a perspective view of an example of the centrifuge of FIG. 8 with the electrical detection unit.

FIG. 12A shows a cross-sectional view of an example of the centrifuge of FIG. 8 with the deposition and extraction mechanism.

FIG. 12B shows a cross-sectional view of an example of a solenoid for use with the centrifuge of FIG. 8.

FIG. 12C shows a perspective view of an example of a liquid sample line for the centrifuge of FIG. 8.

FIG. 13 shows a plan view of an example of the device of FIG. 1 with the holding tank visible.

FIG. 14A shows a perspective view of an example of the device of FIG. 1 with the blunt needle assembly visible.

FIG. 14B show a close-up perspective view of an example of the blunt needle assembly of FIG. 14A.

FIG. 15 shows a perspective view of an example of a holding cylinder for use with the device of FIG. 1.

FIG. 16 shows a perspective view of an example of the device of FIG. 1 in operation in the first position.

FIG. 17 shows a perspective view of an example of the sample deposition and extraction mechanism for use with the device of FIG. 1.

FIG. 18A shows a perspective view of an example of the interior of the mechanism of FIG. 17.

FIG. 18B shows a close-up view of an example of the spiralling grooves in the mechanism of FIG. 17.

FIG. 19 shows a perspective view of the device of an example of FIG. 1 in operation in the second position.

FIG. 20 shows a plan view of an example of an automated qPCR system for use with the device of FIG. 1.

FIG. 21 shows a perspective view an example of of the device of FIG. 1 in operation in the third position.

FIGS. 22A-22C show cross-sectional views of an example of the disposal drum for use with the device of FIG. 1 in three stages of operation.

FIG. 23 shows a plan view of an example of the on-board qPCR cycling system for use with the device of FIG. 1.

FIG. 24 shows a cross-sectional view of an example of the qPCR cycling system of FIG. 23.

FIG. 25 shows a second cross-sectional view of an example of the qPCR cycling system of FIG. 23.

FIG. 26 shows a flowchart of an example embodiment of a method of centrifugation of a fluid sample.

FIG. 27 shows a flowchart of an example embodiment of a method of detecting a presence of a pathogen and strains of a pathogen or a chemical in a fluid sample.

FIG. 28 shows a flowchart of an example embodiment of a method of detecting a presence of a pathogen and strains of a pathogen or a chemical in a fluid sample using an automated qPCR instrument.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

It should also be noted that the use of the term “window” in conjunction with describing the operation of any system or method described herein is meant to be understood as describing a user interface for performing initialization, configuration, or other user operations.

The example embodiments of the devices, systems, or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including at least one of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level procedural language such as object oriented programming. The program code may be written in C++, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

In accordance with the teachings herein, there are provided various embodiments for a device for detecting a presence of a pathogen or a chemical in a fluid sample, the related systems and methods, and computer products for use therewith.

One or more of the embodiments described herein fulfill an unmet need for a field-based, high sensitivity and specificity device for rapid, accurate, and highly sensitive pathogen and chemical detection. For example, an exemplary device completely automates the qPCR process that has traditionally been very manual labor intensive and as a result restricted to use in the laboratory environment. Such a fully automated device requires no manual intervention during the entire qPCR cycle. All steps of the sample analysis from sample acquisition, concentration, lysis, DNA/RNA isolation, amplification, optical detection, and signal processing are fully automated. The device can be used for on-site pathogen and chemical detection and can produce a full qPCR based result within one hour. The applications include foodborne pathogens at food processing plants, general population pathogen detection loads from wastewater, waterways contamination with dangerous pathogens or chemicals, as well as target pathogen detection at highly sensitive facilities that include transportation hubs, retirement facilities, hospitals, and others.

An exemplary device is autonomous (e.g., requiring little or no human interaction during use), and it detects a presence of one or more of a pathogen and one or more strains of a pathogen or a chemical in a fluid sample. This automated device comprises a number of components to detect the presence and/or a quantity of the pathogen, a strain of a pathogen, or a chemical in the fluid sample. An on-board holding tank is configured to store the fluid sample. An on-board fully automated centrifuge for sample concentration of the fluid sample is in fluid communication with the holding tank. A first on-board peristaltic pump is configured to pump the fluid sample from the holding tank into the centrifuge. An automated fluidics sensor management system is operable to transport one or more fluidics sensors to the centrifuge or a qPCR instrument. A rapid qPCR heating system is operable to heat the qPCR instrument. A fluidics sensor rotation and articulation system is configured to receive the one or more fluidics sensors. An electrical signal detection system is operable to detect motion of the centrifuge. A lid heating assembly system is operable to heat the one or more fluidics sensors. An automated sample to fluidics sensor deposition system is configured to receive the one or more fluidics sensors by the centrifuge after use. One or more of the listed components may be omitted or exchanged, for example, to achieve more or less automation.

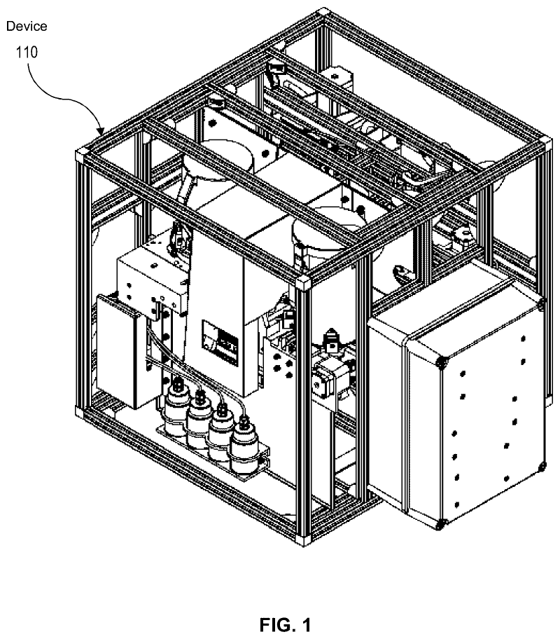

Reference is first made to FIG. 1, showing an example embodiment of an automated device 110 for detecting a presence of one or more of a pathogen and one or more strains of a pathogen or a chemical in a fluid sample. The device 110 has the ability to autonomously obtain a fluid sample, process the fluid sample, manage the on-board pathogen and chemical sensors, and obtain, store, and transfer sensor readings. The device 110 may determine a quantity of the pathogen, a strain of the pathogen, or the chemical in the fluid sample. The device 110 may provide an output of this quantity. The device 110 may determine the presence of the pathogen, a strain of the pathogen, or the chemical in the fluid sample based on this quantity, for example, when the quantity exceeds a threshold.

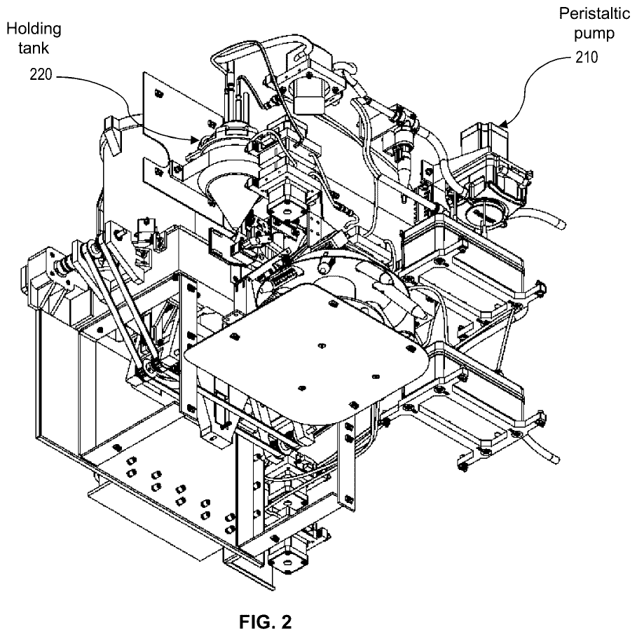

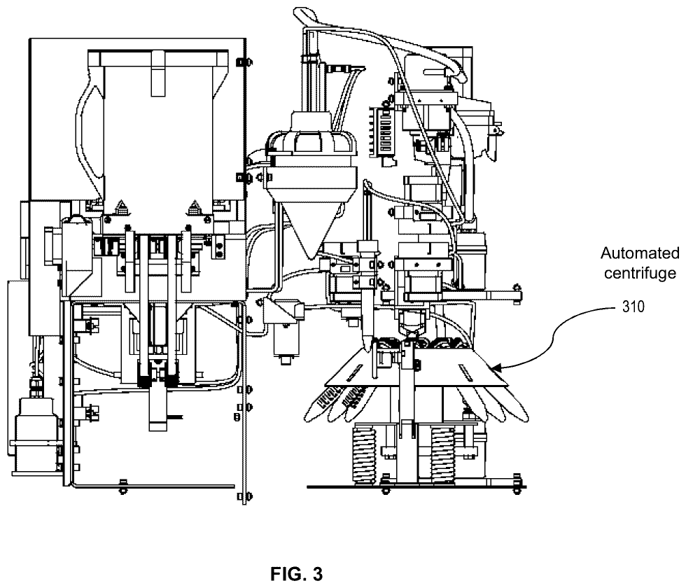

As shown in FIGS. 2 and 3, the device 110 includes a holding tank 220, preferably on on-board holding tank 220, configured to store the fluid sample. The device 110 includes a centrifuge 310, preferably an on-board, fully automated centrifuge 310, for sample concentration. The device 110 includes a first pump 210, preferably an on-board, peristaltic pump 210, configured to pump the fluid sample into the centrifuge 310.

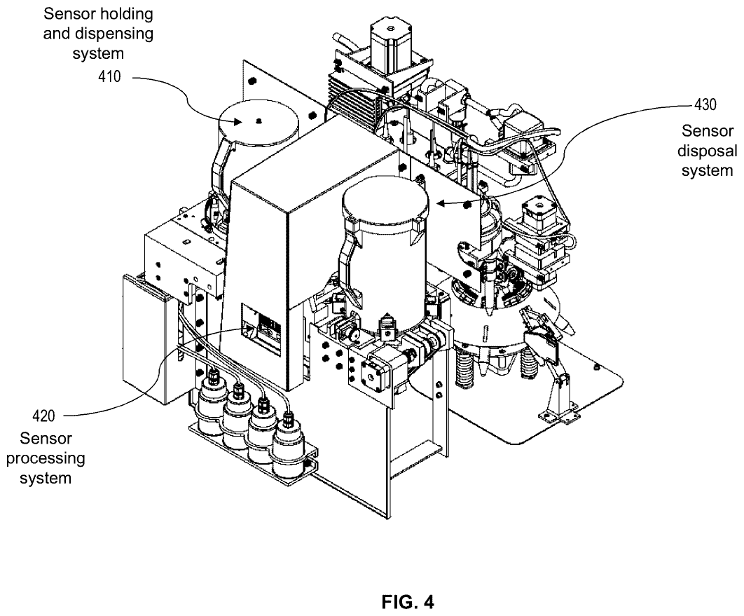

As shown in FIG. 4, the device 110 also includes a fluidics sensor management system 410, preferably an automated fluidics sensor management system 410. The fluidics sensor management system 410 may include a fluidics sensor holding and dispensing system 410, a fluidics sensor processing system 420, and/or a fluidics sensor disposal system 430.

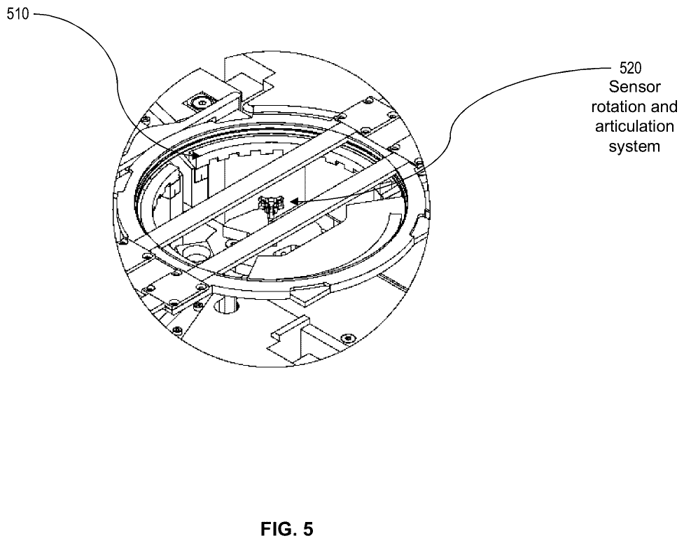

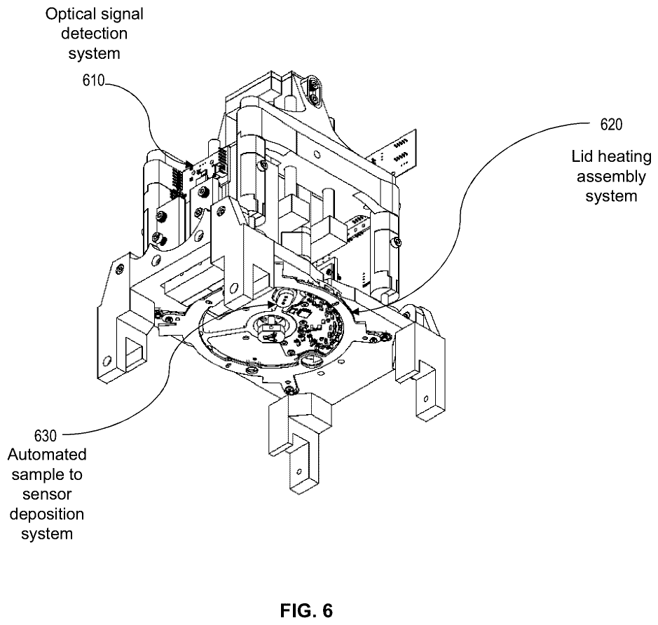

As shown in FIGS. 5 and 6, the device 110 includes heating system 510, preferably a rapid qPCR heating system 510. The device 110 includes a fluidics sensor rotation and articulation system 520. The device 110 includes an optical signal detection system 610. The device 110 includes a lid heating assembly system 620. The device also includes a sample to fluidics sensor deposition system 630, which may be automated.

In at least one embodiment, the device 110 comprises automated means to perform fluid sample acquisition, via an on-board peristaltic pump 210; on-board sample storage in a 500 mL (or other suitable volume) holding tank 220; a sample concentration step via an on-board fully automated centrifuge 310; an automated fluidics sensor management system consisting of a sensor holding and dispensing system 410, a sensor processing system 420, and a sensor disposal system 430; a rapid qPCR heating system 510; a fluidics sensor rotation and articulation system 520; an optical signal detection system 610; a lid heating assembly system 620; and an automated sample to sensor deposition system 630.

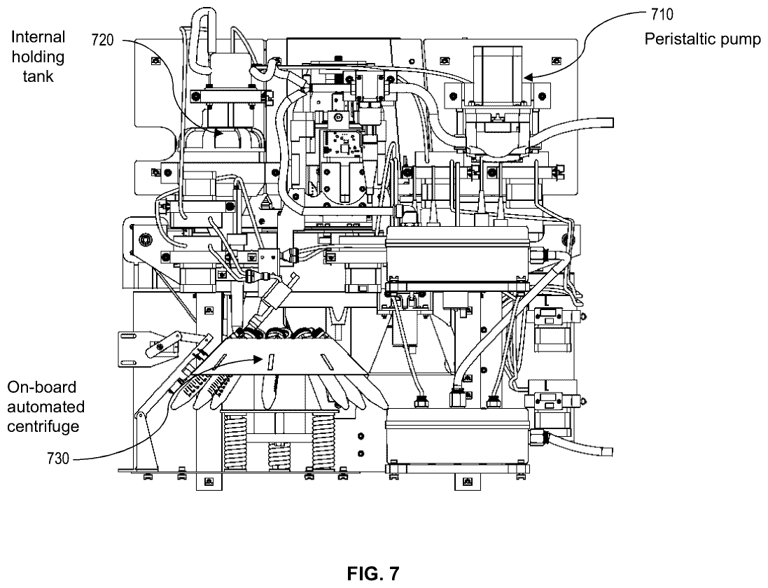

As shown in FIG. 7, the fluid sample (e.g., a water sample) can be pumped into the device 110 via a peristaltic pump 710. The fluid sample can be deposited into an internal holding tank 720 of approximately 500 mL (or other suitable volume).

The device 110 may comprise a second peristaltic pump configured to pump one or more sedimentation chemicals to prepare the fluid sample. For example, sedimentation chemicals may be added to the fluid sample via an additional peristaltic pump to prepare or clean the fluid sample.

In operation, the fluid sample may be urged into the device 110 by any suitable means, such as a fluid sample extraction inlet with tubing positioned at the exterior top side surface of the device 110 connected to the peristaltic pumps (e.g., peristaltic pump 210, peristaltic pump 710) and a fluid disposal outlet on the exterior bottom side surface of the device.

### Automated Centrifuge

The centrifuge 310 may be the on-board automated centrifuge 730 shown in FIG. 7. The description of the centrifuge 730 herein and its functionality are provided in the context of the centrifuge 730 being part of the device 110. Alternatively, the centrifuge 730 may be a modular component that can be attached to or installed within the device 110.

The fluid sample may be pumped via a peristaltic pump into the on-board automated centrifuge 730.

The centrifuge 730 may have disposed therein one or more flasks 810 of approximately 8 mL each, although different volumes may be used.

The centrifuge 730 may be automated to allow for automatic sample deposition, spin, and extraction.

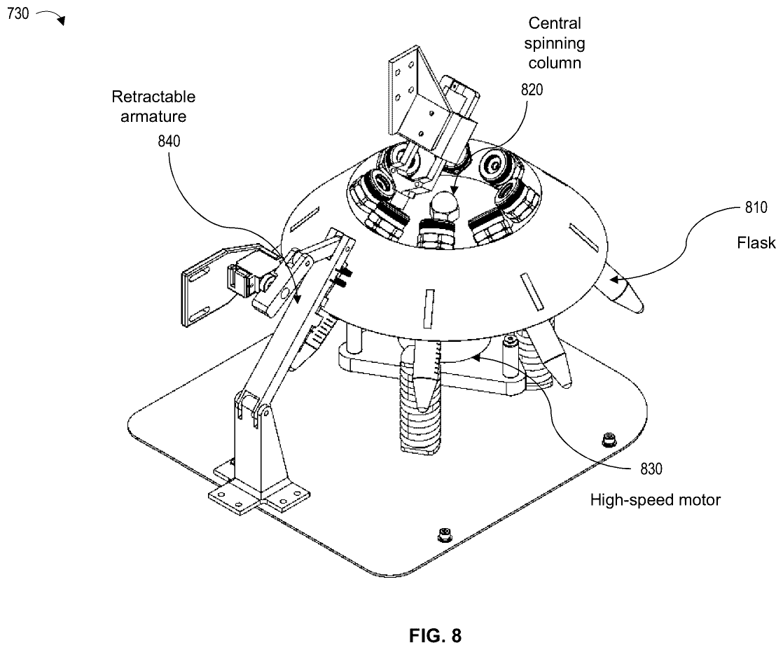

As shown in FIG. 8, the centrifuge 730 may comprise one or more flasks 810 attached to a central spinning column 820 powered by a high-speed motor 830.

The central spinning column 820 may be positionable by a retractable armature 840. In other words, the position of the central spinning column 820 may be controlled by the retractable armature 840, which may be deployed to locate the position of the central spinning column 840 with high degree of precision.

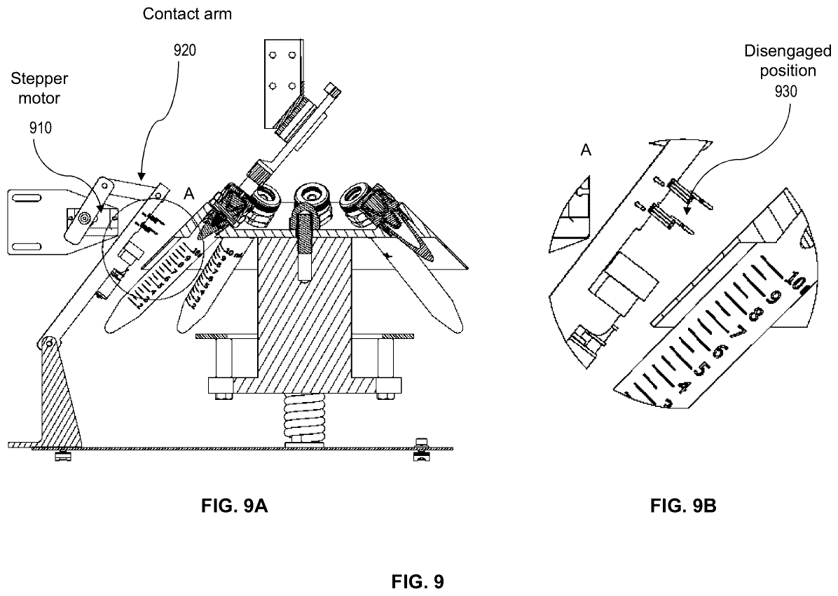

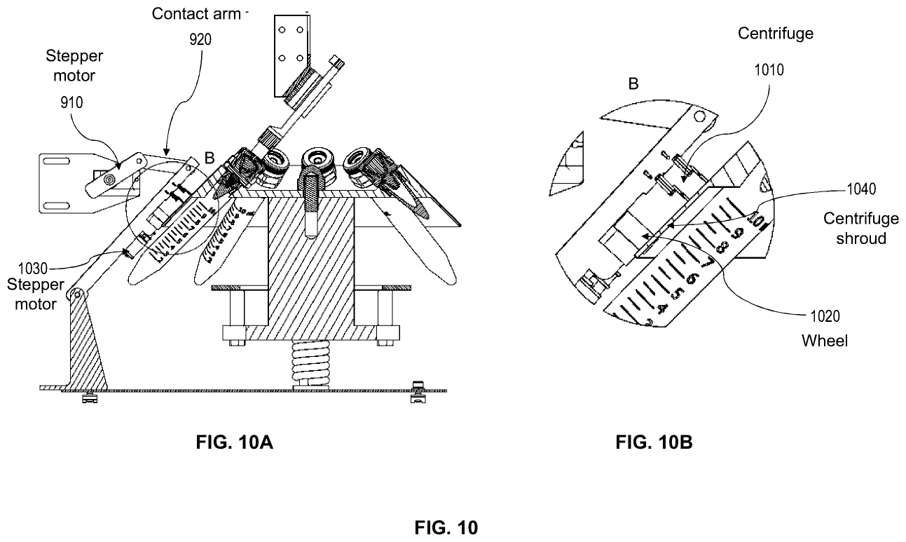

As shown in FIGS. 9A and 9B, the retractable armature 840 may comprise a contact arm 920. The retractable armature 840 may be positionable by a stepper motor 910 that is operable to move the contact arm 920 into a disengaged position 930 when the centrifuge 730 is spinning or in the engaged position 1010 (see FIG. 10B), for example, when precise positioning of the one or more flasks 810 is required. In other words, the armature position may be controlled by the stepper motor 910 that moves the contact arm 920 into the disengaged position 930 when the centrifuge 730 is spinning or in the engaged position 1010 when a more precise flask position is required for sample deposition or sample removal.

As shown in FIG. 10A, in at least one configuration, the stepper motor 1030 may have a wheel 1020 (or other suitable device for displacement or translation) attached thereto. The centrifuge 730 may comprise a centrifuge shroud 1040. In this configuration, when the retractable armature 840 is in an engaged position, the wheel 1020 comes into contact with the centrifuge shroud 1040.

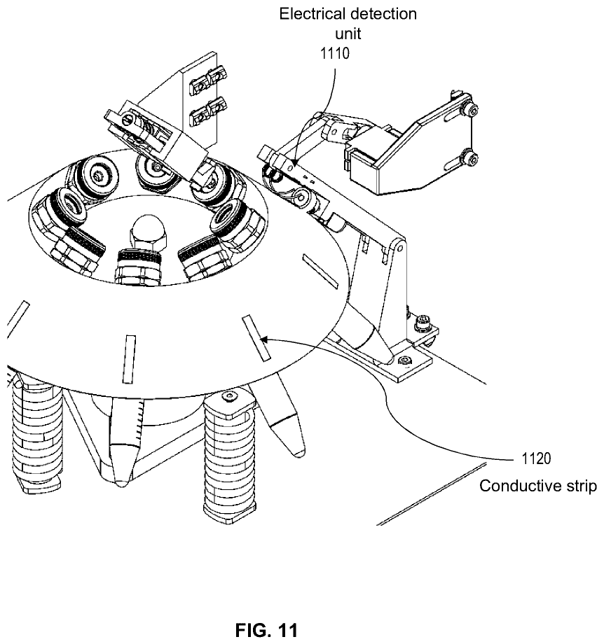

The wheel 1020 may be rotatably coupled to the centrifuge shroud 1040 to cause the centrifuge shroud 1040 to rotate when the stepper motor 1030 is actuated. As such, when the armature 840 is placed in the engaged position, the wheel 1020 attached to the stepper motor 1030 comes into contact with the centrifuge shroud 1040. When the stepper motor 1030 is engaged, the wheel 1020 rotates, causing the centrifuge shroud 1040 to rotate as well. As shown in FIG. 11, the device 110 may comprise an electrical

detection unit 1110. When the armature 840 is in an engaged position, the electrical detection unit 1110 comes into range of the shroud service and comes into contact with the centrifuge shroud 1040. The centrifuge shroud may have disposed thereon conductive strips 1120 at regular intervals. The electrical detection unit 1110 is then operable to detect the conductive strips 1120 while the electrical detection unit 1110 is in contact with the centrifuge shroud 1040 to provide a position for at least one of the one or more flasks 810. In operation, when the electrical elements come into an engaged position, the electrical detection unit 1110 is able to detect conductive strips 1120 placed around the centrifuge shroud 1040 at regular intervals, providing an exact position for the centrifuge shroud 1040 and each flask 810.

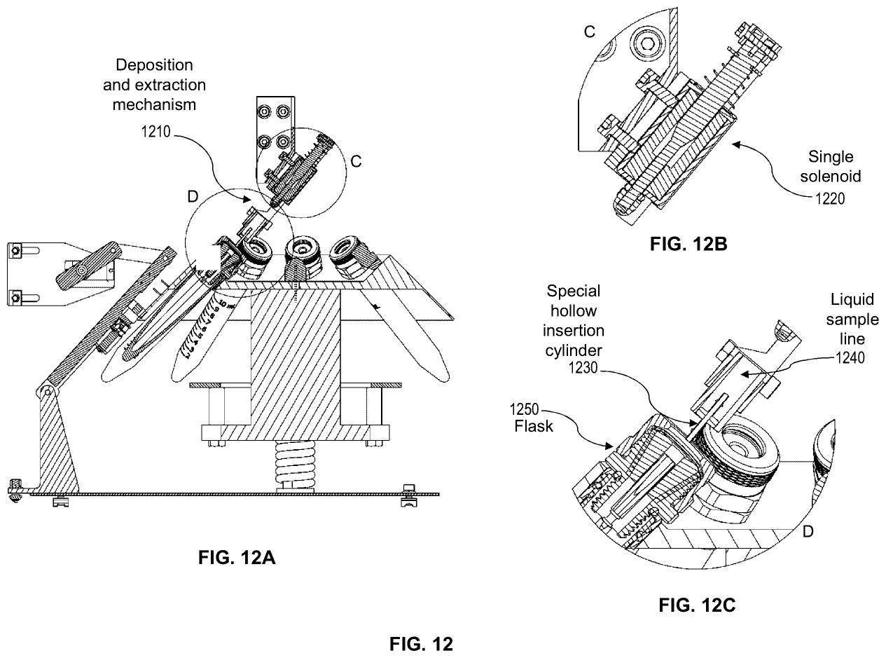

As shown in FIGS. 12A-12C, the device 110 may comprise an automated sample deposition and extraction mechanism 1210. The automated sample deposition and extraction mechanism 1210 can be deployed into each of the centrifuge flasks 810 after they have been positioned by the retractable armature 840.

The automated sample deposition and extraction mechanism 1210 may comprise a single solenoid 1220 mounted to a hollow insertion cylinder 1230 connected to the liquid sample line 1240.

The hollow insertion cylinder 1230 is positionable to enter at least one of the one or more flasks 810 when the solenoid 1220 is engaged. In operation, when the solenoid 1220 is engaged, the hollow insertion cylinder 1230 enters the flask 1250 that has been positioned in front of it.

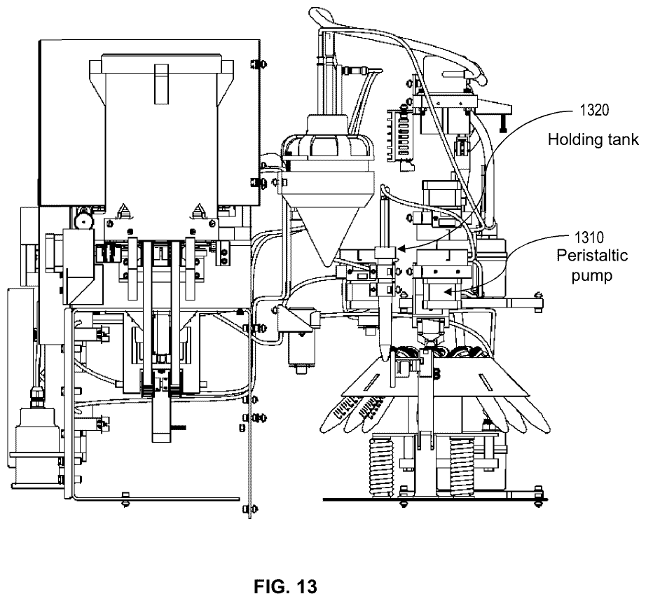

As shown in FIG. 13, the first on-board peristaltic pump 1310 may be configured to urge the fluid sample into one of the flasks 810 when the solenoid 1220 is engaged and to extract the fluid sample from one of the flasks 810 following centrifugation by the centrifuge 730. In operation, once engaged, the peristaltic pump 1310 located upstream of the sample line can be run to either deposit the sample into the flask 810 or extract the sample following centrifugation.

Following centrifugation, either the concentrate or the supernatant from each centrifuge flask 810 may be deposited into a smaller 10 ml holding tank 1320.

### Method of Centrifugation

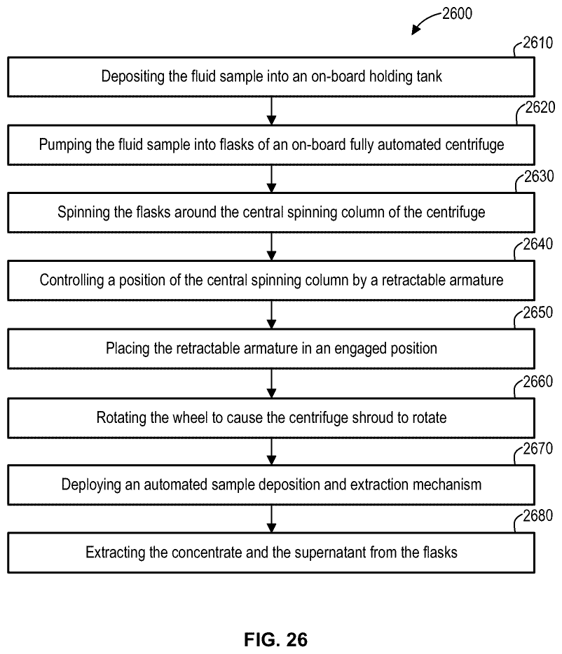

Referring now to FIG. 26, shown therein is a flowchart of an example embodiment of a method 2600 of centrifugation of a fluid sample. Some or all of the device 110 may be used to carry out the method 2600.

Step 2610 is depositing the fluid sample into an on-board holding tank.

Step 2620 is pumping the fluid sample into one or more flasks of an on-board fully automated centrifuge by a first on-board peristaltic pump, the centrifuge comprising a central spinning column and a centrifuge shroud.

Step 2630 is spinning the one or more flasks around the central spinning column of the centrifuge by a high-speed motor, thereby causing centrifugation of the fluid sample to produce a concentrate and a supernatant.

Step 2640 is controlling a position of the central spinning column by a retractable armature.

Step 2650 is placing the retractable armature in an engaged position to make a wheel come into contact with the centrifuge shroud.

Step 2660 is rotating the wheel to cause the centrifuge shroud to rotate.

Step 2670 is deploying an automated sample deposition and extraction mechanism into at least one of the one or more flasks after the at least one of the one or more flasks has been positioned by the retractable armature. Step 2670 may comprise urging a hollow insertion cylinder into at least one of the one or more flasks by a solenoid that is mounted to the hollow insertion cylinder.

Step 2680 is extracting the concentrate and the supernatant from the one or more flasks. Step 2680 may comprise running a peristaltic pump located upstream of the liquid sample line to extract the concentrate and the supernatant following centrifugation.

The method 2600 may further comprise one or more of the following: adding sedimentation chemicals to the fluid sample by a second peristaltic pump; controlling a position of the retractable armature by a stepper motor; moving a contact arm of the retractable armature into a disengaged position when the one or more flasks are spinning; moving the contact arm of the retractable armature into an engaged position to obtain a position of at least one of the one or more flasks; moving the contact arm of the retractable armature into an engaged position to deposit at least one of the one or more flasks; moving the contact arm of the retractable armature into an engaged position to remove at least one of the one or more flasks; providing at least one of a first position for the centrifuge shroud or a second position for one of the one or more flasks when the retractable armature is in the engaged position; running a peristaltic pump located upstream of a liquid sample line to deposit the fluid sample into the one or more flasks; depositing at least one of the concentrate or the supernatant into a holding tank; or depositing a portion of the concentrate by a specially designed blunt needle assembly into a fluidics sensor disk.

In at least one implementation of the method 2600, a stepper motor is engaged to rotate the wheel.

In at least one implementation of the method 2600, an electrical detection unit comes into contact with the centrifuge shroud, the electrical detection unit being operable to detect conductive strips placed around the centrifuge shroud, in order to provide the at least one of the first position for the centrifuge shroud or the second position for the one of the one or more flasks.

### Automated Sample Deposition System

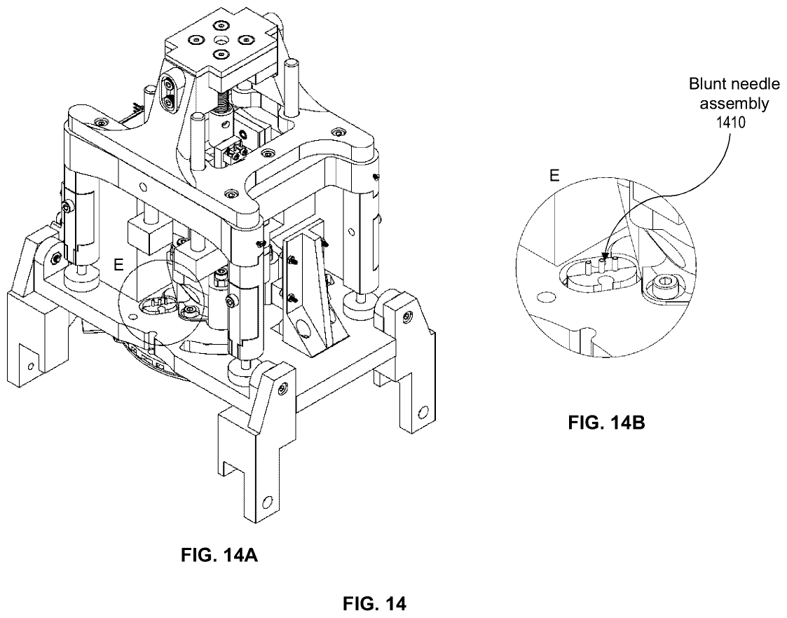

As shown in FIGS. 14A-14B, the automated sample to fluidics sensor deposition system 630 may comprise a blunt needle assembly 1410 and a fluidics sensor disk, where the blunt needle assembly 1410 is positioned to deposit the concentrate or the supernatant into the fluidics sensor disk.

In operation, from the holding tank, 1 mL of concentrate (or other suitable volume) is deposited via the blunt needle assembly 1410 into the fluidics sensor disk, where the rest of the sample processing steps take place.

### Automated Fluidics Sensor Management System

One or more fluidics sensors may be used by the device 110. The fluidics sensors may be substantially cylindrical in form, having suitable dimensions such as 115 mm in diameter and 5 mm in height. The fluidics sensors may be shaped in such a way as to interface with the device sample deposition assembly.

The device 110 may contain an automated fluidics sensor management system that includes sensor storage, sensor loading, and sensor disposal.

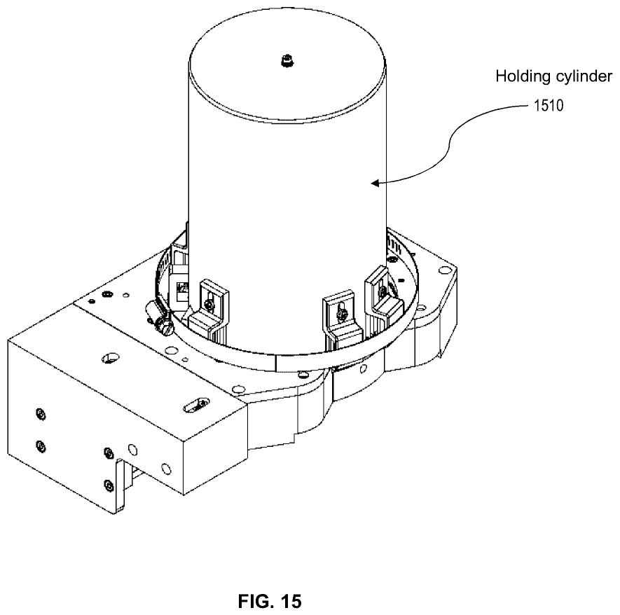

As shown in FIG. 15, the automated fluidics sensor management system storage includes a cylindrical holding container 1510 that can hold one or more fluidics sensors 1610.

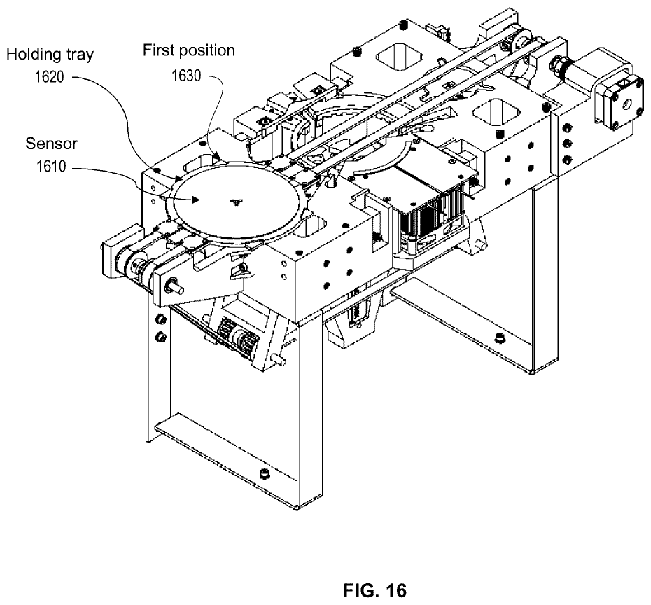

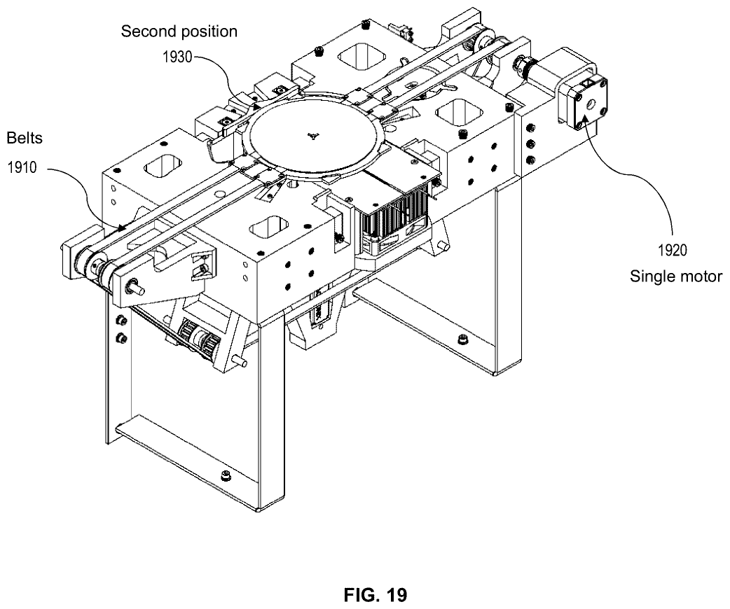

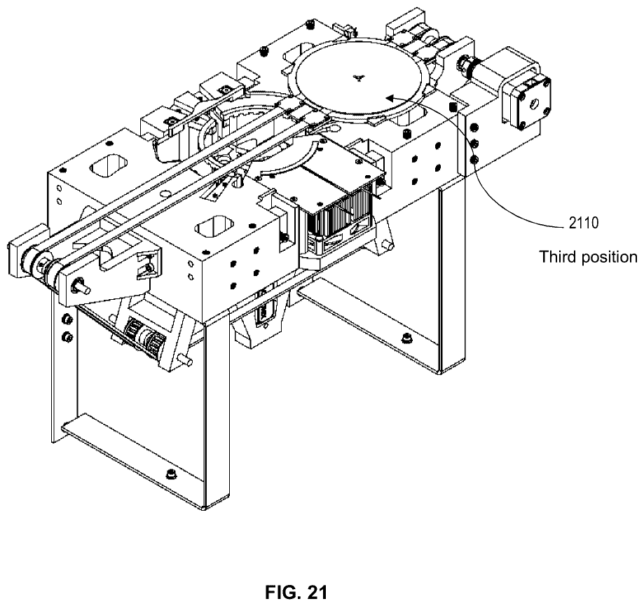

As shown in FIG. 16, the system includes a holding tray 1620 that is movable along a surface of the system from a first position 1630 to a second position 1930 (see FIG. 19) and from the second position 1930 to a third position 2110 (see FIG. 21).

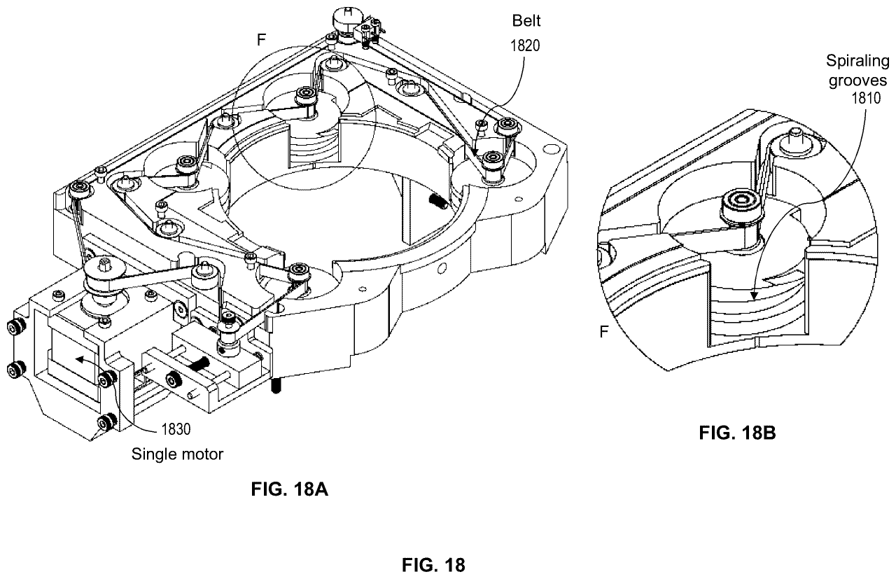

As shown in FIG. 18, the system may comprise at least two belts 1820 connected to a motor 1830 (e.g., a single motor), the at belts 1820 being attached to the holding tray 1620 to move the holding tray 1620 along the surface of the system.

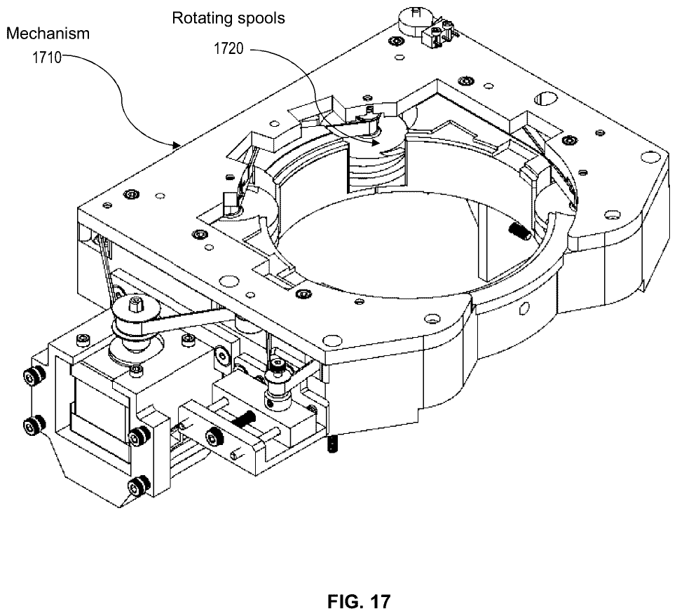

As shown in FIG. 17, the fluidics sensors 1610 are disposed within the cylindrical holding container 1510 that are configured to interface with an automated sample deposition and extraction mechanism 1710. The mechanism 1710 is configured to deposit the fluidics sensors 1610 onto the holding tray 1620. As shown in FIGS. 18A-18B, the mechanism 1710 may comprise at least four rotating spools 1720 with matching spiraling grooves 1810, where the mechanism 1710 is activated by the belts 1820 connected to a motor 1830 to deposit the fluidics sensors 1610 onto the holding tray 1620. Alternatively, the mechanism 1710 may comprise some other number of rotating spools, such as three, where, for example, the three rotating spools are configured (e.g., by special positioning or with the aid of a guide) to operate substantially similarly to four rotating spools.

In operation, the fluidics sensors 1610 are deposited one at a time onto the holding tray 1620 via the mechanism 1710 that consists of at least three rotating spools 1720 with matching spiraling grooves 1810, activated by the belt 1820 connected to the motor 1830.

The mechanism 1710 may be configured to drop the fluidics sensors 1610 onto the at least four rotating spools 1720 while the spools 1720 are rotated. In operation, the mechanism 1710 prevents more than one of the fluidics sensors 1610 from being released onto the holding tray 1620 at a time.

In operation, one of the fluidics sensors 1610 drops onto the spools 1720 and is then drawn down through the spiraling grooves 1810 while the spools 1720 are rotated, the same mechanism preventing more than one fluidics sensor 1610 from being released onto the holding tray 1620 at a time.

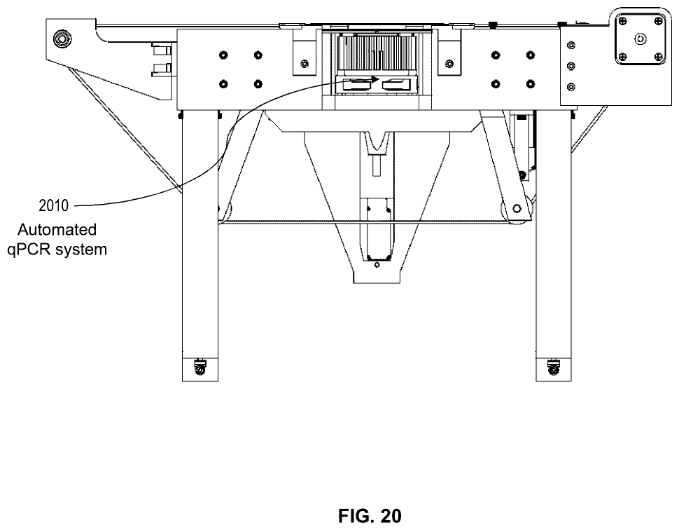

As shown in FIGS. 19-20, the system also includes an automated qPCR instrument 2010 configured to interface with the fluidics sensors 1610. The qPCR instrument 2010 may be located at the second position 1930 where the qPCR instrument 2010 interfaces with the fluidics sensors 1610.

In operation, once a sensor 1610 is dropped onto the holding tray 1620, the holding tray 1620 is moved via two belts 1910 connected to a single motor 1920 into the second position 1930. Here, the fluidics sensor 1610 interfaces with the on-board, automated qPCR system 2010.

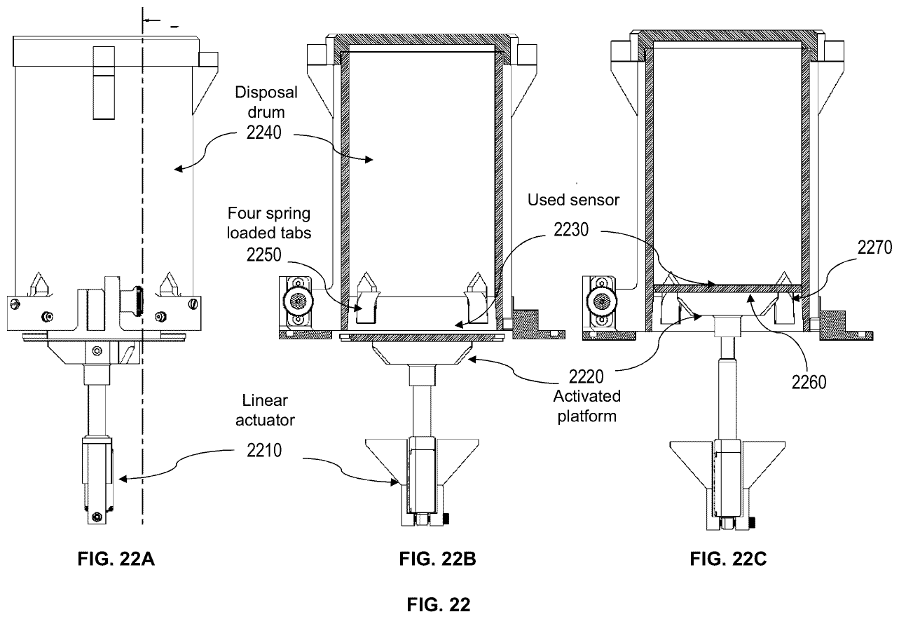

As shown in FIGS. 22A-22C, the system includes a disposal drum 2240 for storing the fluidics sensors 1610. The disposal drum 2240 may be configured to receive the sensors 1610 at the third position 2210. The disposal drum 2240 may be configured to receive any suitable number of fluidics sensors 1610, such as 10 sensors, 33 sensors, 50 sensors, or more.

In operation, upon the conclusion of the test, the fluidics sensor 1610 is moved via the holding tray 1620 into the third position 2110. A linear actuator 2210 activated platform 2220 may lift the used sensor 2230 (e.g., what was previously one of the fluidics sensors 1610 that was used in a test) into the disposal drum 2240.

The platform 2220 may be configured to travel upwards from an original position until the fluidics sensor 1610 pass a plurality of spring-loaded tabs 2250 (e.g., four spring-loaded tabs) that rotate upwards to allow for the fluidics sensor 1610 to pass. In operation, once the fluidics sensor 1610 has passed 2260, the spring-loaded tabs return 2270 (e.g., snap back) to a neutral position to prevent the fluidics sensor 1610 from returning to the original position (e.g., falling back down).

The platform 2220 may be further configured to travel downwards to the original position while the fluidics sensors 1610 remain in the disposal drum 2240.

In operation, the platform 2220 is lowered into the original position while the fluidics sensor 1610 remains in the disposal drum 2240.

This process may be repeated until all fluidics sensors 1610 in the holding drum are depleted and transferred to the disposal drum 2240.

### Method of Detecting the Presence of a Pathogen in a Fluid Sample

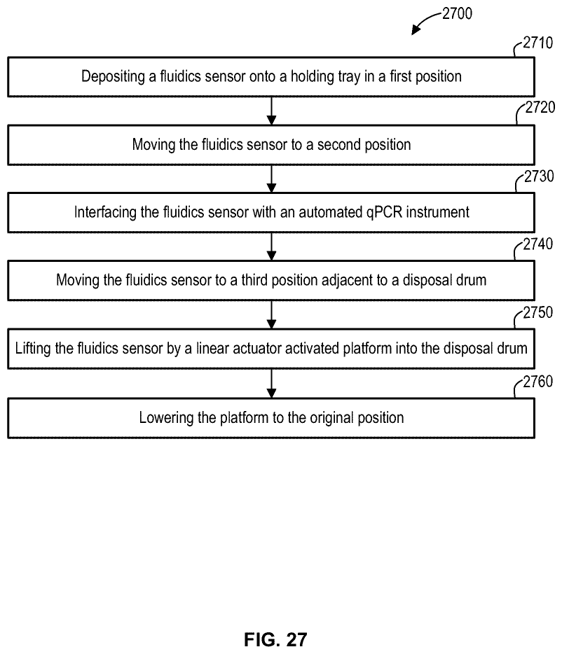

Referring now to FIG. 27, shown therein is a flowchart of an example embodiment of a method 2700 of detecting a presence of one or more of a pathogen and one or more strains of a pathogen or a chemical in a fluid sample. Some or all of the device 110 may be used to carry out the method 2700.

Step 2710 is depositing a fluidics sensor onto a holding tray in a first position. Step 2710 may comprise activating a mechanism by a belt connected to a motor to deposit the fluidics sensor onto the holding tray.

Step 2720 is moving the fluidics sensor to a second position.

Step 2730 is interfacing the fluidics sensor with an automated qPCR instrument.

Step 2740 is moving the fluidics sensor to a third position adjacent to a disposal drum.

Step 2750 is lifting the fluidics sensor by a linear actuator activated platform into the disposal drum from an original position to a stored position. Step 2750 may comprise raising the platform from the original position until the fluidics sensor passes a plurality of spring-loaded tabs that rotate upwards to allow for the fluidics sensor to pass.

Step 2760 is lowering the platform to the original position while the fluidics sensor remains in the disposal drum.

In at least one implementation of the method 2700, the mechanism comprises at least four rotating spools with matching spiralling grooves.

In at least one implementation of the method 2700, the mechanism is configured to drop the fluidics sensor onto the at least four rotating spools while the at least four rotating spools are rotated, the mechanism preventing another fluidics sensor from being released onto the holding tray at the same time.

In at least one implementation of the method 2700, the plurality of spring-loaded tabs are configured to return to a neutral position to prevent the fluidics sensor from falling back down upon passing a first position of the plurality of spring-loaded tabs.

Automated qPCR Instrument

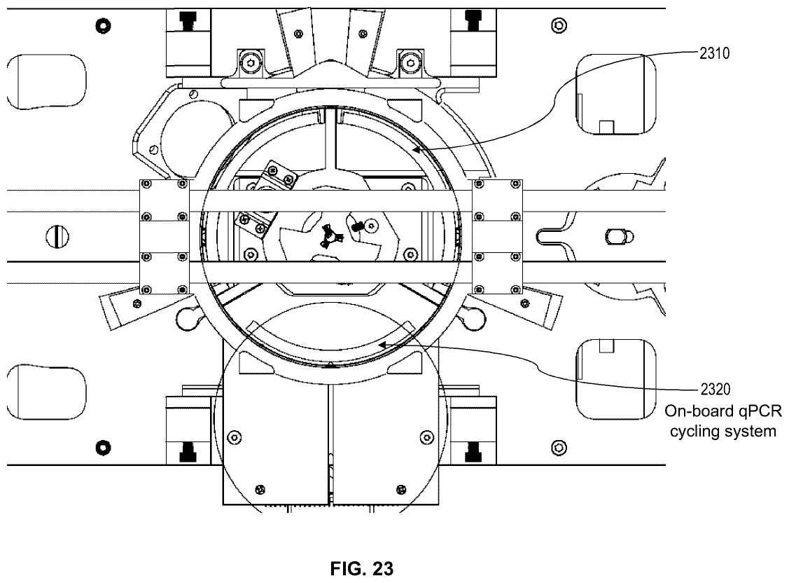

As shown in FIG. 23, an automated qPCR instrument 2310 (which may be referred to as a qPCR system) can be used with the device 110 for detecting the presence of pathogens or strains of a pathogen or a chemical in a fluid sample.

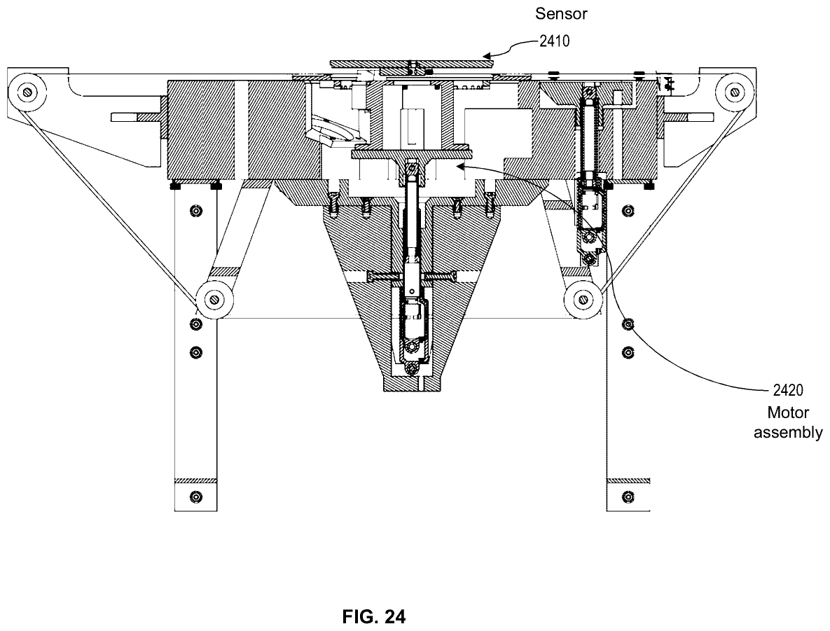

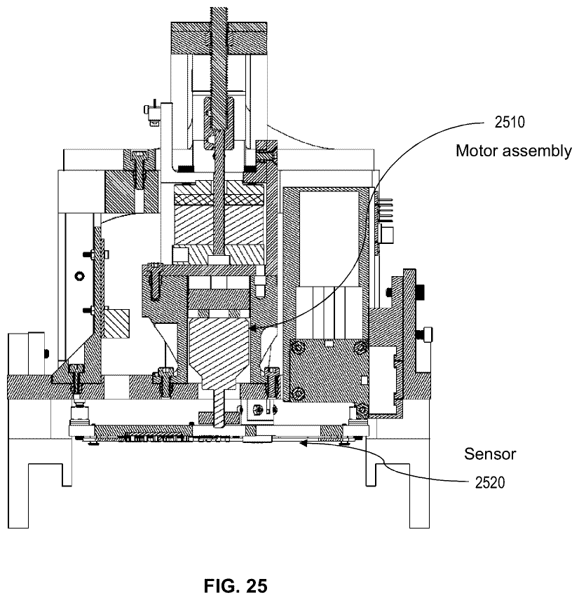

As shown in FIG. 24, the qPCR instrument 2310 comprises a hollow cylindrical body configured to receive a fluidics sensor 2410. The fluidics sensor 2410 may be substantially cylindrical in shape. The qPCR instrument 2310 comprises two or more temperature regulated blocks 2320 (e.g., two blocks, three blocks, or more) arranged along an inner circumference of the hollow cylindrical body. The qPCR instrument 2310 comprises a first motor assembly 2420 for rotating the fluidics sensors 2410 and a second motor assembly 2510 (see FIG. 25) for spinning the fluidics sensors 2410. The qPCR instrument 2310 also comprises a lid heating temperature block 2520 located adjacent to the fluidics sensor 2410. For example, the lid heating temperature block 2520 may be located on a top side of the fluidics sensor 2410. Alternatively, or in addition, the lid heating temperature block 2520 may be located (a) above or below the fluidics sensor 2410; (b) beside the fluidics sensor 2410; or (c) near the fluidics sensor 2410 and in fluid communication with the fluidics sensor 2410 to heat the fluidics sensor 2410.

The on-board qPCR cycling system 2310 may comprise three temperature-regulated blocks 2320 arranged in a circular fashion matching the PCR wells on the sensor fluidics 2410 and located such that the fluidics sensor 2410 rests on top of the blocks 2320 when it reaches this position.

The blocks 2320 may have the shape of annulus sectors and positioned such that the fluidics sensors 2410 rest on top of the blocks 2320 after being received by the hollow cylindrical body.

Each of the lower temperature blocks and the upper temperature block can be set independently to a particular temperature and depending on the temperature required for the qPCR process as dictated by the protocol specified for each fluidics sensor 2410. In operation, the two or more temperature-regulated blocks 2320 can be set to a temperature for qPCR analysis with the fluidics sensor 2410. Alternatively, wherein each of the two or more temperature-regulated blocks 2320 can be independently set to temperatures for qPCR analysis with the fluidics sensor 2410.

The motor assembly 2420 may be positioned over the blocks 2320. In operation, the fluidics sensor 2410 can be rotated via the motor assembly 2420 located below the blocks 2320.

The fluidics sensor 2410 can be spun at high rates to at least 4000 rpm (or any other suitable rate, such as 3000 rpm or 2000 rpm) via a motor assembly 2510 located above the fluidics sensor 2410.

In addition, a lid heating temperature block may be located above the fluidics sensor 2520 (see FIG. 25).

The qPCR instrument 2310 may include a control for activation of temperature blocks (e.g., blocks 2320) and motors (e.g., motor assembly 2510). In operation, the activation of temperature blocks and of the motors can be used to express the qPCR temperature cycle and different thermal regimes used in by different qPCR methods.

Method of Detecting a Pathogen Using an Automated qPCR Instrument

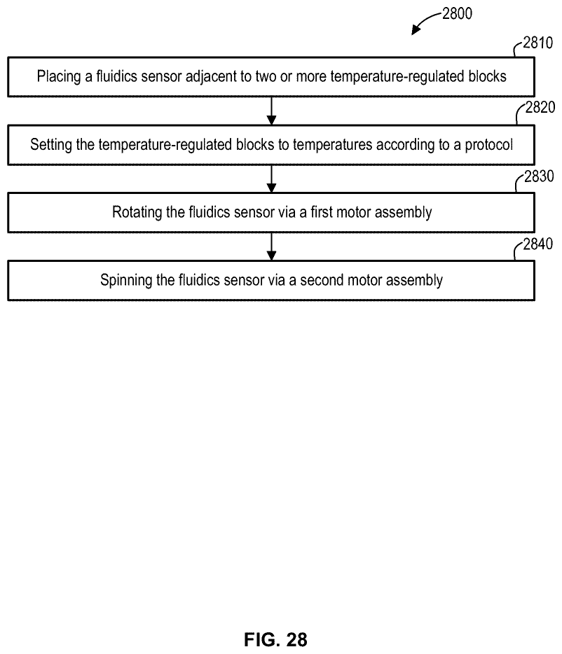

Referring now to FIG. 28, shown therein is a flowchart of an example embodiment of a method 2800 of detecting a presence of at least one of a pathogen and at least one strain of a pathogen or a chemical in a fluid sample using an automated qPCR instrument. Some or all of the device 110 may be used to carry out the method 2800.

Step 2810 is placing a fluidics sensor adjacent to two or more temperature-regulated blocks arranged along an inner circumference of a hollow cylindrical body.

Step 2820 is setting each of the two or more temperature-regulated blocks to corresponding temperatures according to a protocol for the fluidics sensor for qPCR analysis.

Step 2830 is rotating the fluidics sensor via a first motor assembly located adjacent to the two or more temperature-regulated blocks.

Step 2840 is spinning the fluidics sensor via a second motor assembly located adjacent to the fluidics sensor.

In at least one implementation of the method 2800, the two or more temperature-regulated blocks have a shape of annulus sectors and are positioned such that the fluidics sensor rests on top of the two or more temperature-regulated blocks.

In at least one implementation of the method 2800, the two or more temperature-regulated blocks can be set to a single temperature for qPCR analysis with the fluidics sensor.

In at least one implementation of the method 2800, the two or more temperature-regulated blocks can be independently set to temperatures for qPCR analysis with the fluidics sensor.

In at least one implementation of the method 2800, the first motor assembly is positioned over the two or more temperature-regulated blocks.

In at least one implementation of the method 2800, the second motor assembly is positioned over the fluidics sensor.

In at least one implementation of the method 2800, at least one of the first motor assembly or the second motor assembly is configured to spin the fluidics sensor at a spin rate of at least 4000 rpm.

The method 2800 may further comprise activating the two or more temperature-regulated blocks, the first motor assembly, and the second motor assembly to express a qPCR temperature cycle for qPCR analysis.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. An automated device for detecting a presence of one or more of a pathogen and one or more strains of a pathogen or a chemical in a fluid sample, the device comprising:
an on-board holding tank configured to store the fluid sample;
an on-board fully automated centrifuge for sample concentration of the fluid sample, the centrifuge being in fluid communication with the holding tank;
a first on-board peristaltic pump configured to pump the fluid sample from the holding tank into the centrifuge;
an automated fluidics sensor management system operable to transport one or more fluidics sensors to the centrifuge or a qPCR instrument;
a rapid qPCR heating system operable to heat the qPCR instrument;
a fluidics sensor rotation and articulation system configured to receive the one or more fluidics sensors;
an electrical signal detection system operable to detect motion of the centrifuge;
a lid heating assembly system operable to heat the one or more fluidics sensors; and
an automated sample to fluidics sensor deposition system configured to receive the one or more fluidics sensors by the centrifuge after use.

2. The device of claim 1, wherein the fluidics sensor management system comprises:
a fluidics sensor holding and dispensing system;
a fluidics sensor processing system; and
a fluidics sensor disposal system.

3. The device of claim 1, further comprising a second peristaltic pump configured to pump one or more sedimentation chemicals to prepare the fluid sample.

4. The device of claim 1, wherein the centrifuge is automated to allow for automatic deposition, spin, and extraction of the fluid sample.

5. The device of claim 1, wherein the centrifuge comprises one or more flasks attached to a central spinning column powered by a high-speed motor.

6. The device of claim 5, wherein the central spinning column is positionable by a retractable armature.

7. The device of claim 6, wherein the retractable armature comprises a contact arm and the retractable armature is positionable by a stepper motor that is operable to move the contact arm into a disengaged position when the centrifuge is spinning or in the engaged position for positioning of the one or more flasks.

8. The device of claim 7, wherein:
the stepper motor has a wheel attached thereto;
the centrifuge comprises a centrifuge shroud; and
when the retractable armature is in an engaged position, the wheel comes into contact with the centrifuge shroud.

9. The device of claim 8, wherein the wheel is rotatably coupled to the centrifuge shroud to cause the centrifuge shroud to rotate when the stepper motor is actuated.

10. The device of claim 8, further comprising an electrical detection unit, wherein when the retractable armature is in an engaged position, the electrical detection unit comes into contact with the centrifuge shroud.

11. The device of claim 10, wherein:
the centrifuge shroud has disposed thereon conductive strips at regular intervals; and
the electrical detection unit is operable to detect the conductive strips while the electrical detection unit is in contact with the centrifuge shroud to provide a position for at least one of the one or more flasks.

12. The device of claim 6, further comprising an automated sample deposition and extraction mechanism that is deployable by the retractable armature into at least one of the one or more flasks.

13. (canceled)

14. (canceled)

15. (canceled)

16. (canceled)

17. (canceled)

18. An automated fluidics sensor management system for use with a device for detecting a presence of one or more of a pathogen and one or more strains of a pathogen or a chemical in a fluid sample, the system comprising:
a cylindrical holding container;
one or more fluidics sensors disposed within the cylindrical holding container that are configured to interface with an automated sample deposition and extraction mechanism of the device;
a holding tray movable along a surface of the system from a first position to a second position and from the second position to a third position;
a mechanism configured to deposit each of the one or more fluidics sensors, one at a time, onto the holding tray;
an automated qPCR instrument configured to interface with the one or more fluidics sensors; and
a disposal drum for storing the one or more fluidics sensors.

19. The system of claim 18, further comprising a fluidics sensor storage apparatus, a fluidics sensor loading apparatus, and a fluidics sensor disposal apparatus.

20. The system of claim 18, wherein the mechanism comprises at least four rotating spools with matching spiralling grooves and wherein the mechanism is activated by a belt connected to a motor to deposit the one or more fluidics sensors onto the holding tray.

21. The system of claim 20, wherein the mechanism is configured to drop the one or more fluidics sensors, one at a time, onto the at least four rotating spools while the at least four rotating spools are rotated, the mechanism preventing more than one of the one or more fluidics sensors from being released onto the holding tray at a time.

22. The system of claim 18, further comprising at least two belts connected to a motor, the at least two belts being attached to the holding tray to move the holding tray along the surface of the system.

23. The system of claim 18, wherein the automated qPCR instrument is located at the second position where the automated qPCR instrument interfaces with one of the one or more fluidics sensors.

24. The system of claim 18, wherein the disposal drum is configured to receive the one or more fluidics sensors at the third position, where a linear actuator activated platform lifts each of the one or more fluidics sensors into the disposal drum.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A method of centrifugation of a fluid sample, the method comprising:
depositing the fluid sample into an on-board holding tank;
pumping the fluid sample into one or more flasks of an on-board fully automated centrifuge by a first on-board peristaltic pump, the centrifuge comprising a central spinning column and a centrifuge shroud;
spinning the one or more flasks around the central spinning column of the centrifuge by a high-speed motor, thereby causing centrifugation of the fluid sample to produce a concentrate and a supernatant;
controlling a position of the central spinning column by a retractable armature;
placing the retractable armature in an engaged position to make a wheel come into contact with the centrifuge shroud;
rotating the wheel to cause the centrifuge shroud to rotate;
deploying an automated sample deposition and extraction mechanism into at least one of the one or more flasks after the at least one of the one or more flasks has been positioned by the retractable armature; and
extracting the concentrate and the supernatant from the one or more flasks.

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)
